(19) United States
(12) Patent Application Publication
(10) Pub. No.: US 2026/0109209 A1
(43) Pub. Date: Apr. 23, 2026

(54) Aluminum Roll Cover and a Pickup Truck Equipped with the Same

(71) Applicant: Wenzhou Tianmao Automobile Parts Co.,Ltd, Wenzhou City (CN)

(72) Inventors: Lanhua Cai, Wenzhou City (CN); Yonggen Cai, Wenzhou City (CN); Xianzu Chen, Wenzhou City (CN)

(21) Appl. No.: 19/024,309

(22) Filed: Jan. 16, 2025

(30) Foreign Application Priority Data
Oct. 18, 2024 (CN) 202411459093.4

(51) Int. Cl. B60J 7/06; B60J 7/00; B60J 7/19; B60J 10/86

(52) U.S. Cl. CPC B60J 7/068; B60J 7/0084; B60J 7/198; B60J 10/86

(57) ABSTRACT

The present invention discloses an aluminum roll cover and a pickup truck equipped with the aluminum roll cover. It comprises a front cover, an intermediate profile rubber strip assembly, a tailgate, a latch bolt system, a clip system, a guide rail system and a storage box. By providing the storage box, the present invention facilitates the rolling up and storage of the roll cover. Moreover, a spring is arranged inside the storage box, and the elastic force of the spring is utilized for rolling up, which saves time and effort and is convenient to operate.

### CROSS REFERENCE TO RELATED APPLICATION

This application claims priority benefit of Chinese patent Application No. 202411459093.4, filed on Oct. 18, 2024, and the entire contents of which are incorporated herein by reference.

### TECHNICAL FIELD

The present invention belongs to the field of pickup truck covers, and specifically relates to an aluminum roll cover.

### BACKGROUND TECHNOLOGY

Pickups are an important part of the automobile market. A pickup is a vehicle type that adopts a car front end and a cab while having an open truck bed. Its characteristics are that it has the comfort of a car without losing its strong power, and it has a stronger ability to carry goods and adapt to poor road conditions than a car. The most common pickup vehicle type is the double-cab pickup. Pickups can be used as special-purpose vehicles, multi-purpose vehicles, official vehicles and commercial vehicles, and can also be used as family vehicles for carrying goods, traveling, renting, etc. The so-called “pickup” is a hybrid of a car and a truck. With the expansion of the scale of modification enthusiasts, pickup modification is increasingly becoming a popular category among modification enthusiasts.

Existing pickup truck covers are divided into soft covers and hard covers. Compared with hard covers, soft covers can be opened more widely. However, soft covers usually have the following problems during use:
1. Different from the folding of hard covers, most soft covers are opened by rolling up. In this way, during the use process, the rolled-up soft cover is not convenient to place, which causes inconvenience for transporting some taller goods with a pickup truck using a soft cover.
2. Since the soft cover is composed of multiple profiles spliced together, how to handle the waterproofing between profiles is the key to the quality of the soft cover.
3. The soft cover needs to be rolled up frequently. How to design it so that the soft cover does not become loose after multiple roll-ups is also a problem to be solved in this application.

CONTENTS OF THE INVENTION

In order to solve the above problems existing in the prior art, the technical scheme adopted by the present invention is as follows:
An aluminum roll cover, it comprises a front cover, an intermediate profile rubber strip assembly, a tailgate, a latch bolt system, a clip system, a guide rail system and a storage box;
The storage box includes an outer box, a storage box gear, a second gearbox axis, a first flange, a second flange gasket, a second flange, a first storage box axis, a front fence fixing part of the storage box, a first flange gasket and a spring;
The second gearbox axis through the second flange gasket and the second flange is connected to the outer box. The storage box gear is connected to the second gearbox axis. The first storage box axis through the first flange and the first flange gasket is connected to the outer box. The front fence fixing part of the storage box is connected to the first storage box axis. The spring is arranged inside the first storage box axis, and both ends of the spring are respectively connected to the two first flanges.

By setting up a storage box, it is convenient to roll up and store the roll cover. Moreover, a spring is arranged inside the storage box, and the elastic force of the spring is utilized for rolling up, which saves time and effort and is convenient to operate.

An aluminum roll cover, it comprises a front cover, an intermediate profile rubber strip assembly, a tailgate, a latch bolt system, a clip system, a guide rail system and a storage box;
The storage box includes an outer box, a storage box gear, a second gearbox axis, a first flange, a second flange gasket, a second flange, a first storage box axis, a front fence fixing part of the storage box, a first flange gasket and a spring;
The second gearbox axis through the second flange gasket and the second flange is connected to the outer box. The storage box gear is connected to the second gearbox axis. The first storage box axis through the first flange and the first flange gasket is connected to the outer box. The front fence fixing part of the storage box and the first storage box axis are of an integrated structure. The spring is arranged inside the first storage box axis, and both ends of the spring are respectively connected to the two first flanges.

Further, the outer box includes an outer box splicing part, an outer box drain outlet, an outer box waterproof rubber strip and an outer box flanging;
The top of the outer box is provided with an outer box flanging, the outer box flanging is connected with an outer box waterproof rubber strip, the bottom of the outer box is provided with an outer box drain outlet, and the outer box is formed by splicing multiple plates, and the connection between the plates is provided with an outer box splicing part.

Further, the front cover is provided with a cover plate and a front cover water retaining strip, the front cover water retaining strip is arranged on the underside of the cover plate, the cover plate is provided with cover plate fixing hole, the cover plate fixing hole are used to connect the guide rail system, and the guide rail system is connected to the body of the pickup truck.

Further, the storage box gear is provided with gear teeth;
The front fence fixing part of the storage box is provided with a front fence intermediate rod notch;
The intermediate profile rubber strip assembly includes multiple intermediate profiles and multiple intermediate rubber strips, the intermediate profiles and the intermediate rubber strips are distributed alternately, the intermediate profile is provided with an intermediate profile groove, and the intermediate rubber strip is provided with a second finger of the intermediate rubber strip;
The intermediate profile groove is matched with the gear teeth, and the front fence intermediate rod notch is matched with the second finger of the intermediate rubber strip.

The storage box gear is used to guide the rolling up and unfolding of the intermediate profile rubber strip assembly.

Further, the storage box gear is connected to the second gearbox axis, and the second gearbox axis is provided with a hexagonal structure of the second shaft of the storage box;
The second flange includes a second flange shaft and second flange fixing holes, and the second flange through the second flange fixing holes is connected to the outer box and the second flange gasket;
The storage box gear further includes a storage box gear hole, and the storage box gear hole is matched with the hexagonal structure of the second shaft of the storage box;
The gear teeth are used to position the storage box gear on the second gearbox axis.

The gear teeth are used to position the storage box gear on the second gearbox shaft.

Further, the first storage box axis and the front fence fixing part of the storage box are of a detachable structure. The front fence fixing part of the storage box includes a front fence intermediate rod notch, a first protrusion for front fence fixing and multiple intermediate fixing protrusions for front fence fixing. The first storage box axis includes a protrusion of the first storage box axis. The intermediate fixing protrusions for front fence fixing are matched with the protrusion of the first storage box axis, and the arc between the first protrusion for front fence fixing and the second protrusion for front fence fixing is greater than 180°.

Further, the first flange is provided with a first flange hanging shaft, and the first flange hanging shaft is snapped into the first storage box axis and fixed between the two first flanges.

Further, the first flange is provided with a first flange hook hole, and both ends of the spring are provided with spring hooks, and the spring hooks are connected to the first flange hook hole.

Further, the waterproof rubber strip on the side of the outer box is arranged on the underside of the outer box flanging.

The beneficial effects of the present invention are as follows: By setting up a lower sliding strip, the present invention uses the lower sliding strip to support the intermediate profile rubber strip assembly. Through the design of the structure of the lower sliding strip, the intermediate profile rubber strip assembly and the lower sliding strip maintain line contact, thereby ensuring the smooth sliding of the intermediate profile rubber strip assembly. Secondly, by setting up a lower blocking waterproof rubber strip, rainwater is concentrated in the guide rail channel, which can play a very good waterproof role.

### ILLUSTRATIONS OF THE DRAWINGS

FIG. 1 is the installation schematic diagram of the present invention.

FIG. 2 is the first structural schematic diagram of the present invention.

FIG. 3 is the second structural schematic diagram of the present invention.

FIG. 4 is the third structural schematic diagram of the present invention.

FIG. 5 is the fourth structural schematic diagram of the present invention.

FIG. 6 is the partial enlarged view of part A in FIG. 5.

FIG. 7 is the fifth structural schematic diagram of the present invention.

FIG. 8 is the partial enlarged view of part B in FIG. 7.

FIG. 9 is the first structural schematic diagram of the inside of the storage box in the present invention.

FIG. 10 is the partial enlarged view of part C in FIG. 9.

FIG. 11 is the second structural schematic diagram of the inside of the storage box in the present invention.

FIG. 12 is the partial enlarged view of part D in FIG. 11.

FIG. 13 is the partial enlarged view of part E in FIG. 11.

FIG. 14 is the rolling up schematic diagram of the present invention.

FIG. 15 is the third structural schematic diagram of the inside of the storage box in the present invention.

FIG. 16 is the partial enlarged view of part F in FIG. 15.

FIG. 17 is the fourth structural schematic diagram of the inside of the storage box in the present invention.

FIG. 18 is the partial enlarged view of part G in FIG. 17.

FIG. 19 is the exploded view of the first storage box shaft in the present invention.

FIG. 20 is the side view of the first storage box shaft in the present invention.

FIG. 21 is the sectional view in the H-H direction in FIG. 20.

FIG. 22 is the connection schematic diagram of the latch bolt system in the present invention.

FIG. 23 is the sixth structural schematic diagram of the present invention.

In the Figure: 1—Front Cover; 11—Cover Plate; 1101—Cover Plate Fixing Hole; 12—Front Cover Water Retaining Strip; 2—Intermediate Profile Rubber Strip Assembly; 2101—Intermediate Profile Groove; 2201—Second Finger of Intermediate Rubber Strip; 3—Tailgate; 32—Tailgate Hook; 4—Latch Bolt System; 41—Latch Bolt; 42—First Lock Base; 43—Steel Wire; 44—Pull Rope of the Lock System; 45—Lock Fixing Block; 46—Second Lock Base; 47—Lock Block; 5—Clip System; 6—Guide Rail System; 6601—Guide Rail Rear Joint Locking Groove; 7—Storage Box; 71—Outer Box; 7101—Outer Box Spling Part; 7102—An Outer Box Drain Outlet; 7103—An Outer Box Waterproof Rubber Strip; 7104—Outer Box Flanging; 7105—Waterproof Rubber Strip on Side of Outer Box; 72—Storage Box Gear; 7201—Gear Teeth; 7202—Protrusion of Storage Box Gear; 7203-Storage Box Gear Hole; 73—Second Gearbox Axis; 7301—Hexagonal structure of the second shaft of the storage box; 74—First Flange; 7401—First Flange Hook Hole; 7402—First Flange Hanging Shaft; 75—Second Flange Gasket; 76—Second Flange; 7601—Second Flange Shaft; 7602—Fixing Hole of Second Flange; 77—First Storage Box Axis; 7701—Hole of First Storage Box Axis; 7702—Protrusion of First Storage Box Axis; 78—Front Fence Fixing Part of the Storage Box; 7801—Front Fence Intermediate Rod Notch; 7802—First Protrusion for Front Fence Fixing; 7803—Second Protrusion for Front Fence Fixing; 7804—Intermediate Fixing Protrusion for Front Fence Fixing; 79—First Flange Gasket; 80—Spring; 801—Spring Hook.

### SPECIFIC IMPLEMENTATION MODES

The present invention will be further elaborated below in combination with the attached drawings and reference numerals.

In order to understand the above-mentioned purposes, features and advantages of the present invention more clearly, the present invention will be described in detail below in combination with the attached drawings and specific embodiments. It should be noted that, in the absence of conflict, the embodiments of the present application and the features in the embodiments can be combined with each other.

The terms “first”, “second”, “third”, etc. are only used for distinguishing descriptions and cannot be understood as indicating or implying relative importance.

In the description of the present invention, it should also be noted that, unless otherwise clearly specified and limited, the terms “set”, “install”, “connect”, “link” should be understood in a broad sense. For example, it can be a fixed connection, a detachable connection, or an integral connection; it can be a mechanical connection or an electrical connection; it can be directly connected or indirectly connected through an intermediate medium, and it can be the internal communication of two elements. For ordinary technicians in the field, the specific meanings of the above terms in the present invention can be understood according to specific situations.

The specific implementation modes of the present invention will be described in detail below in combination with the attached drawings. It should be understood that the specific implementation modes described here are only used for illustration and explanation of the present invention and are not used to limit the present invention.

### EXAMPLE 1

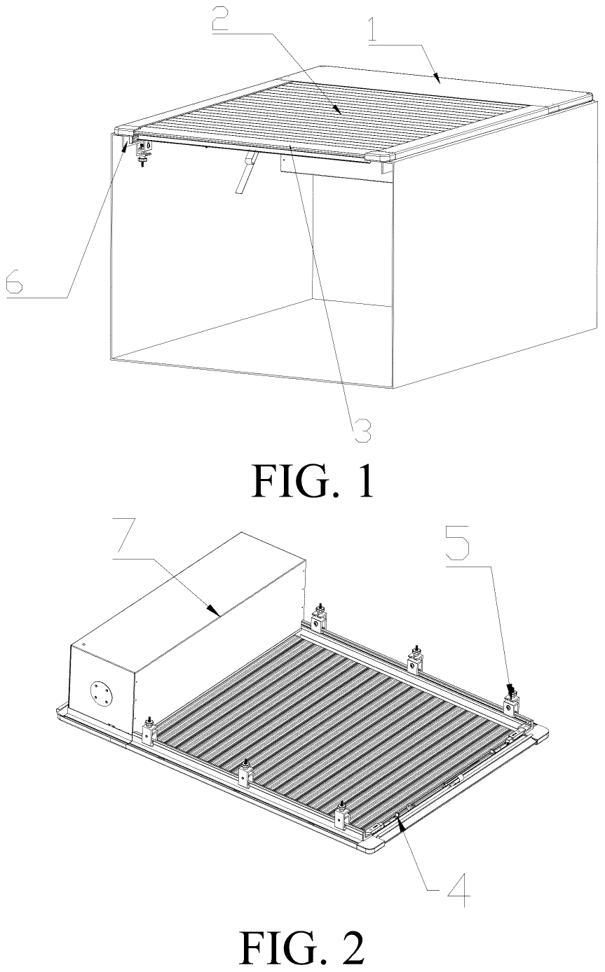

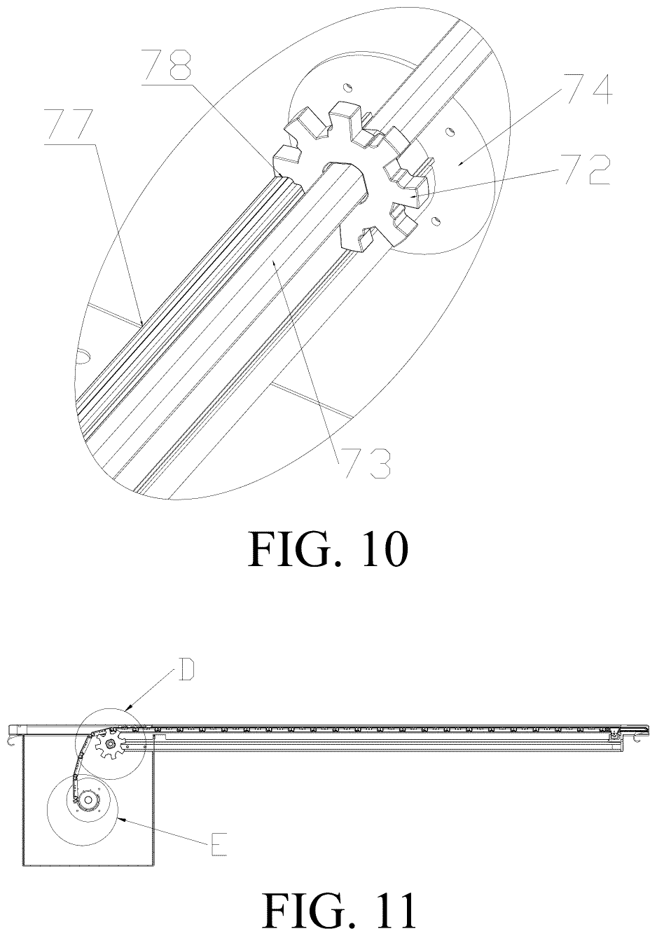

As shown in FIGS. 1, 2, 9, 10 and 19, an aluminum roll cover, characterized in that it comprises a front cover 1, an intermediate profile rubber strip assembly 2, a tailgate 3, a latch bolt system 4, a clip system 5, a guide rail system 6 and a storage box 7;
The storage box 7 includes an outer box 71, a storage box gear 72, a second gearbox axis 73, a first flange 74, a second flange gasket 75, a second flange 76, a first storage box axis 77, a front fence fixing part of the storage box 78, a first flange gasket 79 and a spring 80;
The second gearbox axis 73 through the second flange gasket 75 and the second flange 76 is connected to the outer box 71. The storage box gear 72 is connected to the second gearbox axis 73. The first storage box axis 77 through the first flange 74 and the first flange gasket 79 is connected to the outer box 71. The front fence fixing part of the storage box 78 is connected to the first storage box axis 77. The spring 80 is arranged inside the first storage box axis 77, and both ends of the spring 80 are respectively connected to the two first flanges 74.

By setting up a storage box, it is convenient to roll up and store the roll cover. Moreover, a spring 80 is arranged inside the storage box, and the elastic force of the spring is utilized for rolling up, which saves time and effort and is convenient to operate.

### EXAMPLE 2

As shown in FIGS. 1, 2, 9, 10 and 19, an aluminum roll cover, characterized in that it comprises a front cover 1, an intermediate profile rubber strip assembly 2, a tailgate 3, a latch bolt system 4, a clip system 5, a guide rail system 6 and a storage box 7;
The storage box 7 includes an outer box 71, a storage box gear 72, a second gearbox axis 73, a first flange 74, a second flange gasket 75, a second flange 76, a first storage box axis 77, a front fence fixing part of the storage box 78, a first flange gasket 79 and a spring 80;
The second gearbox axis 73 through the second flange gasket 75 and the second flange 76 is connected to the outer box 71. The storage box gear 72 is connected to the second gearbox axis 73. The first storage box axis 77 through the first flange 74 and the first flange gasket 79 is connected to the outer box 71. The front fence fixing part of the storage box 78 and the first storage box axis 77 are of an integrated structure. The spring 80 is arranged inside the first storage box axis 77, and both ends of the spring 80 are respectively connected to the two first flanges 74.

### Example 3

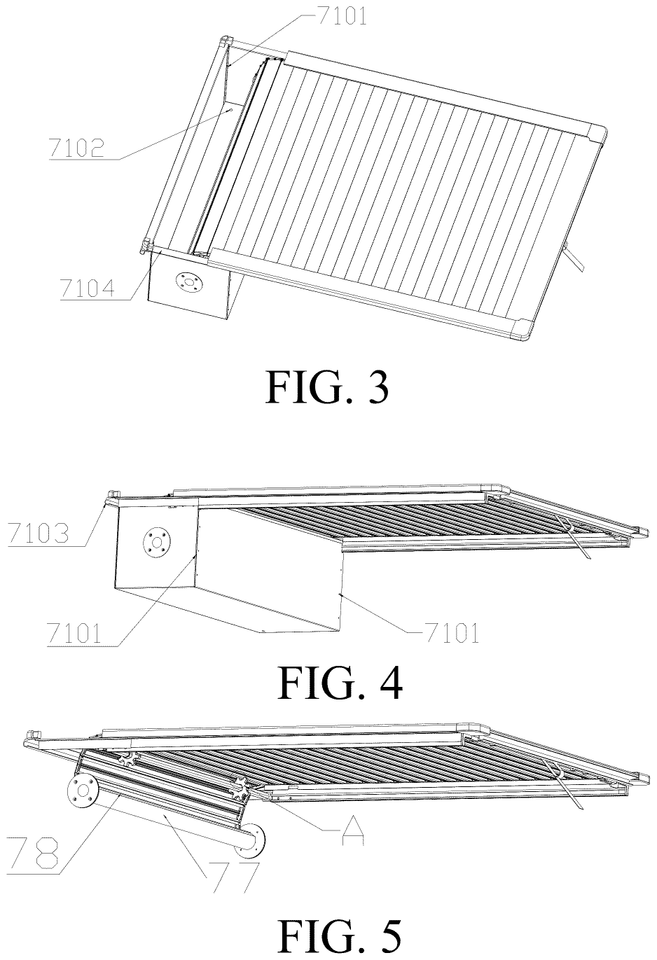

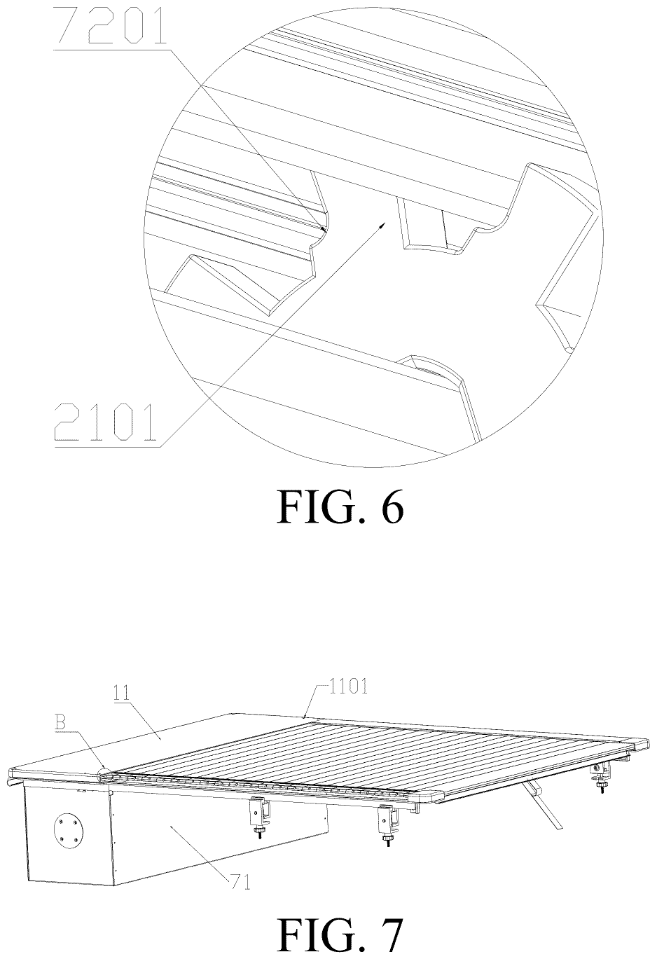

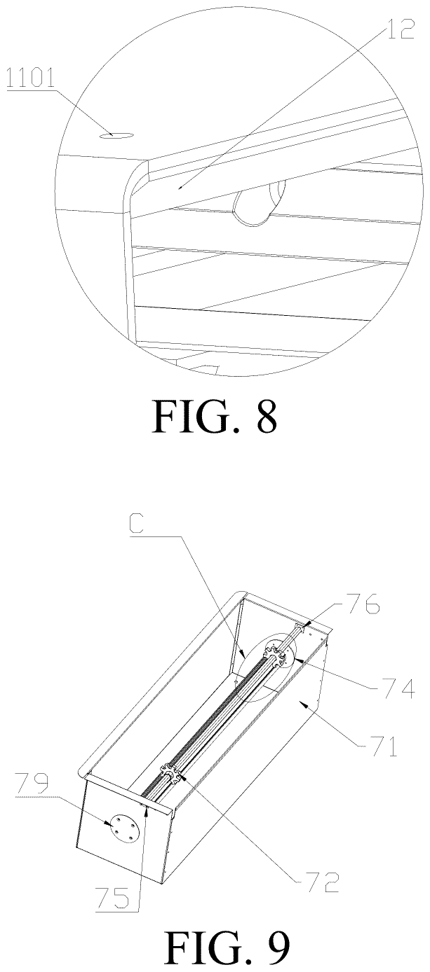

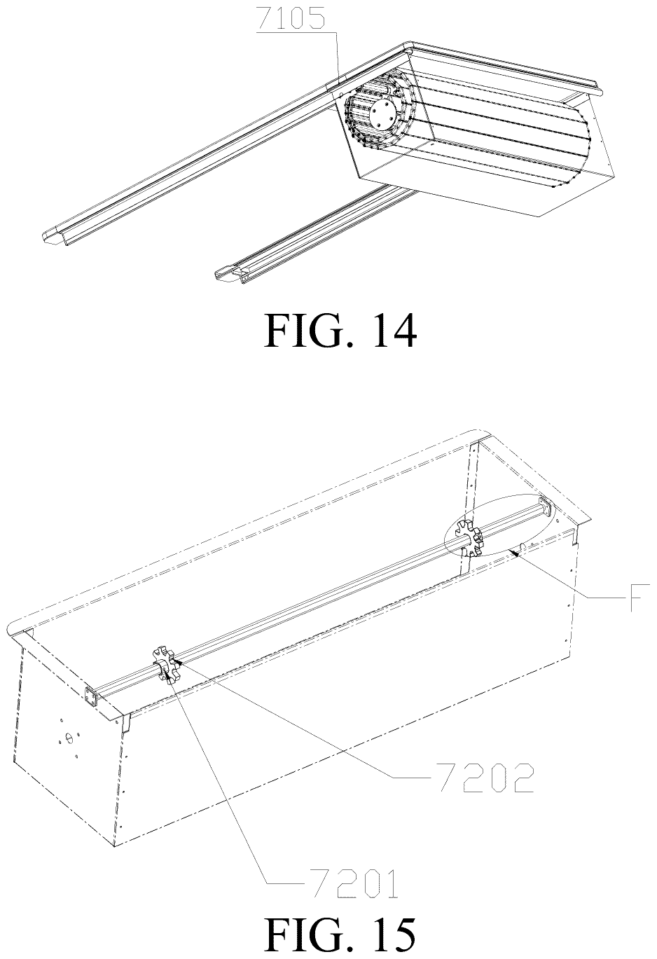

On the basis of Examples 1 and 2, as shown in FIGS. 3-8, 14 , the outer box 71 includes an outer box splicing part 7101, an outer box drain outlet 7102, an outer box waterproof rubber strip 7103 and an outer box flanging 7104;
The top of the outer box 71 is provided with an outer box flanging 7104, the outer box flanging 7104 is connected with an outer box waterproof rubber strip 7103, the bottom of the outer box 71 is provided with an outer box drain outlet 7102, and the outer box 71 is formed by splicing multiple plates, and the connection between the plates is provided with an outer box splicing part 7101.

### EXAMPLE 4

On the basis of Examples 1 and 2, as shown in FIGS. 3-8 , the front cover 1 is provided with a cover plate 11 and a front cover water retaining strip 12, the front cover water retaining strip 12 is arranged on the underside of the cover plate 11, the cover plate 11 is provided with cover plate fixing hole 1101, the cover plate fixing hole 1101 are used to connect the guide rail system 6, and the guide rail system 6 is connected to the body of the pickup truck.

### EXAMPLE 5

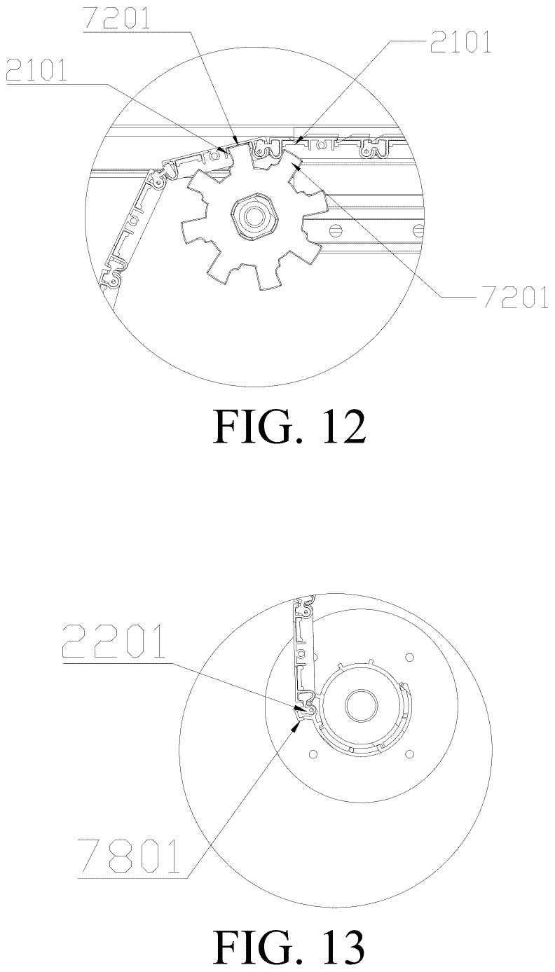

On the basis of Examples 1 and 2, as shown in FIGS. 11-13, the storage box gear 72 is provided with gear teeth 7201;
The front fence fixing part of the storage box 78 is provided with a front fence intermediate rod notch 7801;
The intermediate profile rubber strip assembly 2 includes multiple intermediate profiles and multiple intermediate rubber strips, the intermediate profiles and the intermediate rubber strips are distributed alternately, the intermediate profile is provided with an intermediate profile groove 2101, and the intermediate rubber strip is provided with a second finger of the intermediate rubber strip 2201;
The intermediate profile groove 2101 is matched with the gear teeth 7201, and the front fence intermediate rod notch 7801 is matched with the second finger of the intermediate rubber strip 2201.

The storage box gear 72 is used to guide the rolling up and unfolding of the intermediate profile rubber strip assembly 2.

### EXAMPLE 6

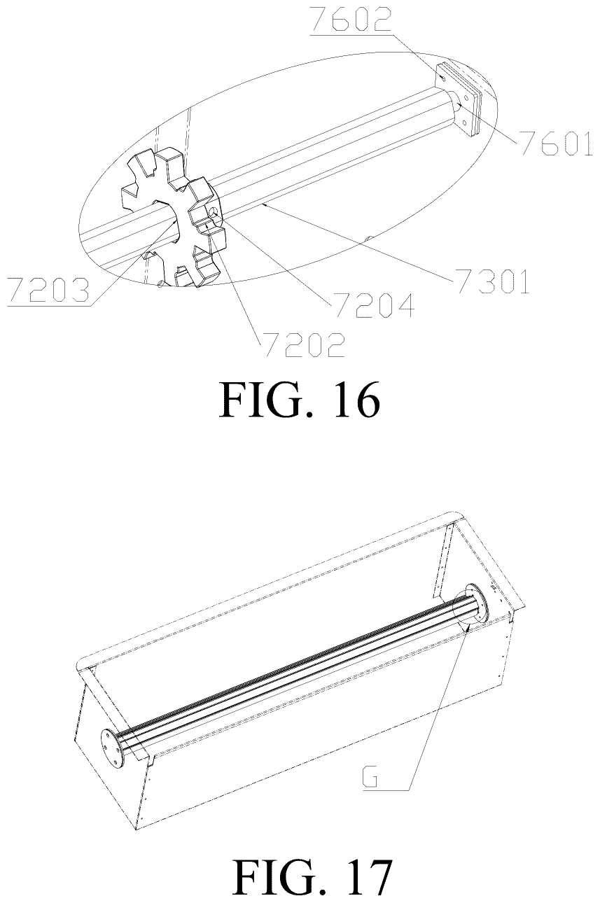

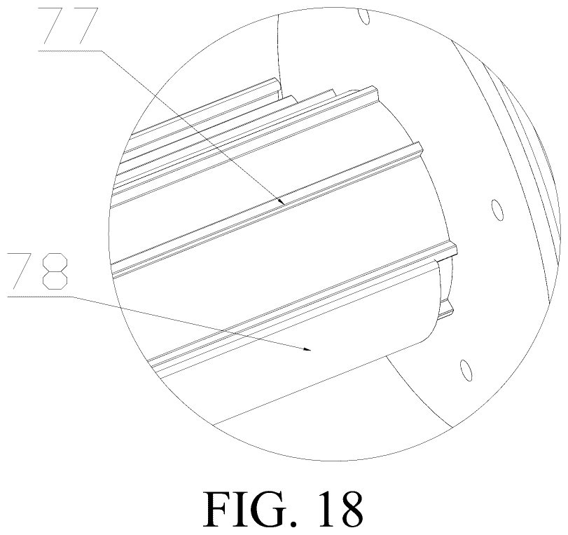

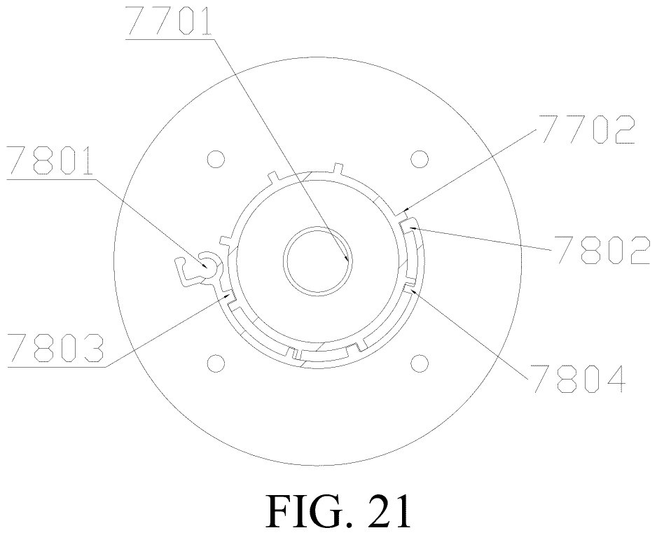

On the basis of Example 5, as shown in FIGS. 15-21 , the storage box gear 72 is connected to the second gearbox axis 73, and the second gearbox axis 73 is provided with a hexagonal structure of the second shaft of the storage box 7301;
The second flange 76 includes a second flange shaft 7601 and second flange fixing holes 7602, and the second flange 76 through the second flange fixing holes 7602 is connected to the outer box 71 and the second flange gasket 75;
The storage box gear 72 further includes a storage box gear hole 7203, and the storage box gear hole 7203 is matched with the hexagonal structure of the second shaft of the storage box 7301;
The gear teeth 7201 are used to position the storage box gear 72 on the second gearbox axis 73. In order to adapt to the structure of the soft cover, a protrusion of the storage box gear 7202 is also set on the storage box gear 72 to cooperate with the soft cover.

### EXAMPLE 7

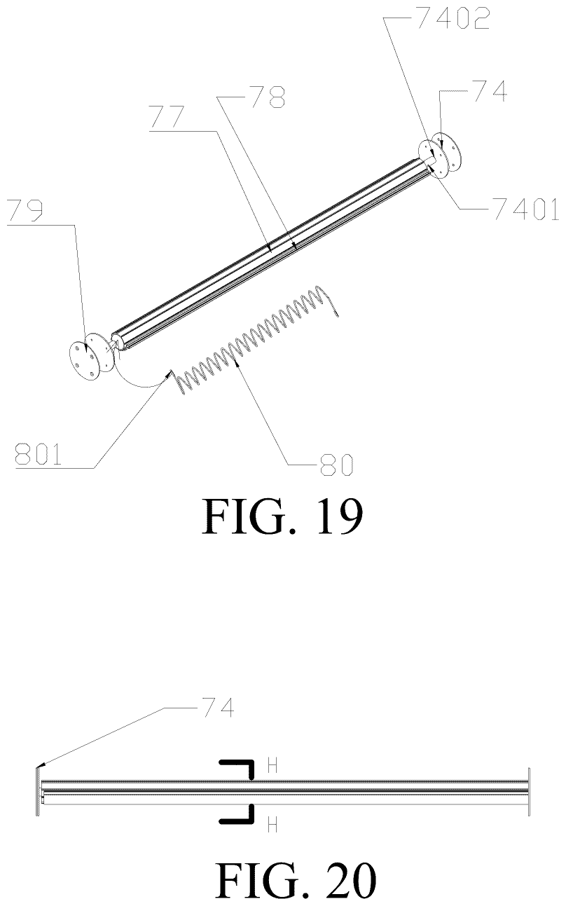

On the basis of Example 1, as shown in FIGS. 19-21 , the first storage box axis 77 and the front fence fixing part of the storage box 78 are of a detachable structure. The front fence fixing part of the storage box 78 includes a front fence intermediate rod notch 7801, a first protrusion for front fence fixing 7802 and multiple intermediate fixing protrusions for front fence fixing 7804. The first storage box axis 77 includes a protrusion of the first storage box axis 7702. The intermediate fixing protrusions for front fence fixing 7804 are matched with the protrusion of the first storage box axis 7702, and the arc between the first protrusion for front fence fixing 7802 and the second protrusion for front fence fixing 7803 is greater than 180°.

### EXAMPLE 8

On the basis of Examples 1 and 2, as shown in FIGS. 19-21 , the first flange 74 is provided with a first flange hanging shaft 7402, and the first flange hanging shaft 7402 is snapped into the first storage box axis 77 and fixed between the two first flanges 74.

### EXAMPLE 9

On the basis of Example 8, the first flange 74 is provided with a first flange hook hole 7401, and both ends of the spring 80 are provided with spring hooks 801, and the spring hooks 801 are connected to the first flange hook hole 7401.

### EXAMPLE 10

On the basis of Example 3, the waterproof rubber strip on the side of the outer box 7105 is arranged on the underside of the outer box flanging 7104.

### EXAMPLE 11

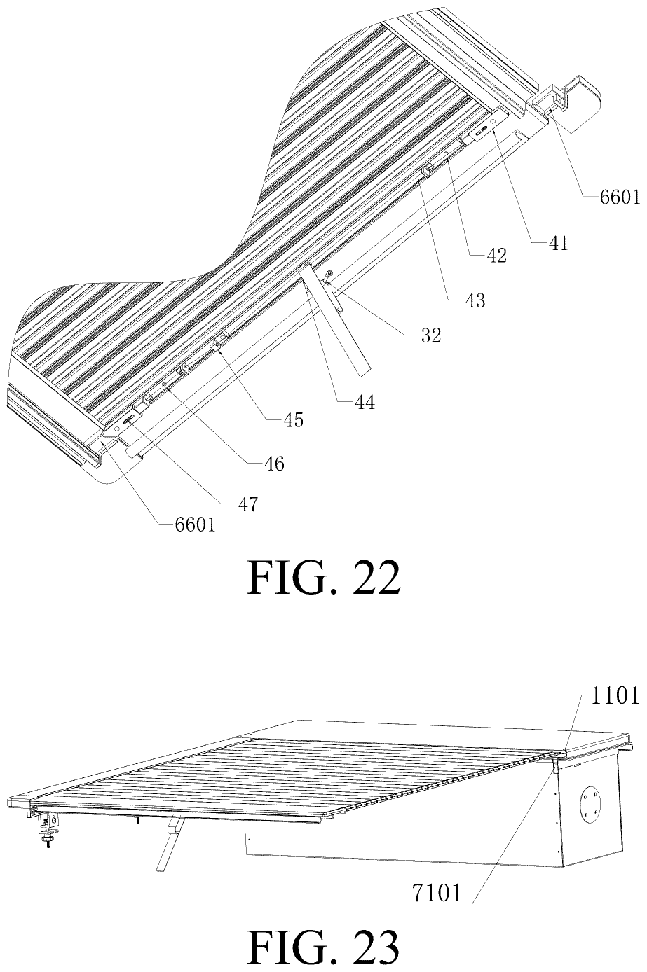

On the basis of Examples 1 and 2, as shown in FIGS. 22 and 23, the latch bolt system 4 includes a latch bolt 41, a first lock base 42, a wire 43, a pull rope of the lock system 44, a lock fixing block 45, a second lock base 46 and a lock block 47;

Both the latch bolt 41 and the lock block 47 are connected to the guide rail rear joint locking groove 6601. The latch bolt 41, the first lock base 42, the pull rope of the lock system 44 and the lock fixing block 45 are connected in series by the wire 43, the pull rope of the lock system 44 is pulled, the latch bolt 41 and the lock block 47 can be opened.

The tailgate 3 is provided with a hook for the pull rope of the tailgate 32, and the pull rope of the lock system 44 is connected to the hook for the pull rope of the tailgate 32.

The tailgate 3 is the component that is opened most frequently. Therefore, how to open it conveniently is the key to the tailgate. By setting up the pull rope of the lock system 44, the lock can be easily unlocked by simply pulling the pull rope of the lock system 44. In addition, by setting up the tailgate hook 32, the pull rope of the lock system 44 can be hung on the tailgate hook 32, making the whole more tidy.

The present invention is not limited to the above optional implementation modes. Anyone can obtain other various forms of products under the inspiration of the present invention. However, no matter what changes are made to its shape or structure, any technical solution that falls within the scope defined by the claims of the present invention is within the protection scope of the present invention.

1. An aluminum roll cover, characterized in that it comprises a front cover (1), an intermediate profile rubber strip assembly (2), a tailgate (3), a latch bolt system (4), a clip system (5), a guide rail system (6) and a storage box (7);
The storage box (7) includes an outer box (71), a storage box gear (72), a second gearbox axis (73), a first flange (74), a second flange gasket (75), a second flange (76), a first storage box axis (77), a front fence fixing part of the storage box (78), a first flange gasket (79) and a spring (80);
The second gearbox axis (73) through the second flange gasket (75) and the second flange (76) is connected to the outer box (71). The storage box gear (72) is connected to the second gearbox axis (73). The first storage box axis (77) through the first flange (74) and the first flange gasket (79) is connected to the outer box (71). The front fence fixing part of the storage box (78) is connected to the first storage box axis (77). The spring (80) is arranged inside the first storage box axis (77), and both ends of the spring (80) are respectively connected to the two first flanges (74).

2. An aluminum roll cover, characterized in that it comprises a front cover (1), an intermediate profile rubber strip assembly (2), a tailgate (3), a latch bolt system (4), a clip system (5), a guide rail system (6) and a storage box (7);
The storage box (7) includes an outer box (71), a storage box gear (72), a second gearbox axis (73), a first flange (74), a second flange gasket (75), a second flange (76), a first storage box axis (77), a front fence fixing part of the storage box (78), a first flange gasket (79) and a spring (80);
The second gearbox axis (73) through the second flange gasket (75) and the second flange (76) is connected to the outer box (71). The storage box gear (72) is connected to the second gearbox axis (73). The first storage box axis (77) through the first flange (74) and the first flange gasket (79) is connected to the outer box (71). The front fence fixing part of the storage box (78) and the first storage box axis (77) are of an integrated structure. The spring (80) is arranged inside the first storage box axis (77), and both ends of the spring (80) are respectively connected to the two first flanges (74).

3. The aluminum roll cover according to claim 1 or 2, characterized in that: the outer box (71) includes an outer box splicing part (7101), an outer box drain outlet (7102), an outer box waterproof rubber strip (7103) and an outer box flanging (7104);
The top of the outer box (71) is provided with an outer box flanging (7104), the outer box flanging (7104) is connected with an outer box waterproof rubber strip (7103), the bottom of the outer box (71) is provided with an outer box drain outlet (7102), and the outer box (71) is formed by splicing multiple plates, and the connection between the plates is provided with an outer box splicing part (7101).

4. The aluminum roll cover according to claim 1 or 2, characterized in that: the front cover (1) is provided with a cover plate (11) and a front cover water retaining strip (12), the front cover water retaining strip (12) is arranged on the underside of the cover plate (11), the cover plate (11) is provided with cover plate fixing hole (1101), the cover plate fixing hole (1101) are used to connect the guide rail system (6), and the guide rail system (6) is connected to the body of the pickup truck.

5. The aluminum roll cover according to claim 1 or 2, characterized in that: the storage box gear (72) is provided with gear teeth (7201);
The front fence fixing part of the storage box (78) is provided with a front fence intermediate rod notch (7801);
The intermediate profile rubber strip assembly (2) includes multiple intermediate profiles and multiple intermediate rubber strips, the intermediate profiles and the intermediate rubber strips are distributed alternately, the intermediate profile is provided with an intermediate profile groove (2101), and the intermediate rubber strip is provided with a second finger of the intermediate rubber strip (2201);
The intermediate profile groove (2101) is matched with the gear teeth (7201), and the front fence intermediate rod notch (7801) is matched with the second finger of the intermediate rubber strip (2201).

6. The aluminum roll cover according to claim 5, characterized in that: the storage box gear (72) is connected to the second gearbox axis (73), and the second gearbox axis (73) is provided with a hexagonal structure of the second shaft of the storage box (7301);
The second flange (76) includes a second flange shaft (7601) and second flange fixing holes (7602), and the second flange (76) through the second flange fixing holes (7602) is connected to the outer box (71) and the second flange gasket (75);
The storage box gear (72) further includes a storage box gear hole (7203), and the storage box gear hole (7203) is matched with the hexagonal structure of the second shaft of the storage box (7301);
The gear teeth (7201) are used to position the storage box gear (72) on the second gearbox axis (73).

7. The aluminum roll cover according to claim 1, characterized in that: the first storage box axis (77) and the front fence fixing part of the storage box (78) are of a detachable structure. The front fence fixing part of the storage box (78) includes a front fence intermediate rod notch (7801), a first protrusion for front fence fixing (7802) and multiple intermediate fixing protrusions for front fence fixing (7804). The first storage box axis (77) includes a protrusion of the first storage box axis (7702). The intermediate fixing protrusions for front fence fixing (7804) are matched with the protrusion of the first storage box axis (7702), and the arc between the first protrusion for front fence fixing (7802) and the second protrusion for front fence fixing (7803) is greater than 180°.

8. The aluminum roll cover according to claim 1 or 2, characterized in that: the first flange (74) is provided with a first flange hanging shaft (7402), and the first flange hanging shaft (7402) is snapped into the first storage box axis (77) and fixed between the two first flanges (74).

9. The aluminum roll cover according to claim 8, characterized in that: the first flange (74) is provided with a first flange hook hole (7401), and both ends of the spring (80) are provided with spring hooks (801), and the spring hooks (801) are connected to the first flange hook hole (7401).

10. The aluminum roll cover according to claim 3, characterized in that: the waterproof rubber strip on the side of the outer box (7105) is arranged on the underside of the outer box flanging (7104).

11. The aluminum roll cover according to claim 1, characterized in that: the latch bolt system (4) includes a latch bolt (41), a first lock base (42), a wire (43), a pull rope of the lock system a lock fixing block (45), a second lock base (46) and a lock block (47);
Both the latch bolt (41) and the lock block (47) are connected to the guide rail rear joint locking groove (6601). The latch bolt (41), the first lock base (42), the pull rope of the lock system (44) and the lock fixing block (45) are connected in series by the wire (43);
The tailgate (3) is provided with a hook for the pull rope of the tailgate (32), and the pull rope of the lock system (44) is connected to the hook for the pull rope of the tailgate (32).
